(19) United States
(12) Patent Application Publication
(10) Pub. No.: US 2018/0134199 A1
(43) Pub. Date: May 17, 2018

(54) Handle System

(71) Applicant: Reynaldo Mejia, Orlando, FL (US)

(72) Inventor: Reynaldo Mejia, Orlando, FL (US)

(21) Appl. No.: 15/353,910

(22) Filed: Nov. 17, 2016

(51) Int. Cl. B60N 3/02; B62D 33/02

(52) U.S. Cl. CPC B60N 3/02; B62D 33/02

(57) ABSTRACT

A handle system for attaching to a pickup bed thereby assisting with climbing into and out of the pickup bed includes a vehicle that has a bed. A handle unit is coupled to the bed and the handle unit is gripped to assisting a user to climb into the bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to handle devices and more particularly pertains to a new handle device for attaching to a pickup bed thereby assisting with climbing into and out of the pickup bed.

### BRIEF SUMMARY OF THE INVENTION

An embodiment of the disclosure meets the needs presented above by generally comprising a vehicle that has a bed. A handle unit is coupled to the bed and the handle unit is gripped to assisting a user to climb into the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a handle unit of a handle system according to an embodiment of the disclosure.

FIG. 2 is a bottom view of a handle unit of an embodiment of the disclosure.

FIG. 3 is a front view of a handle unit of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

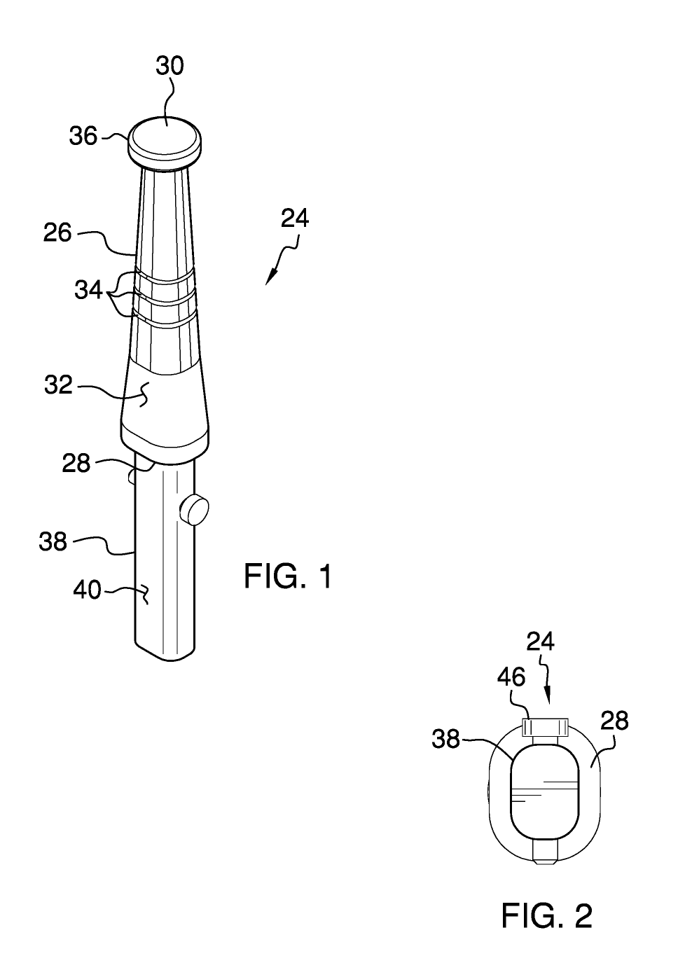

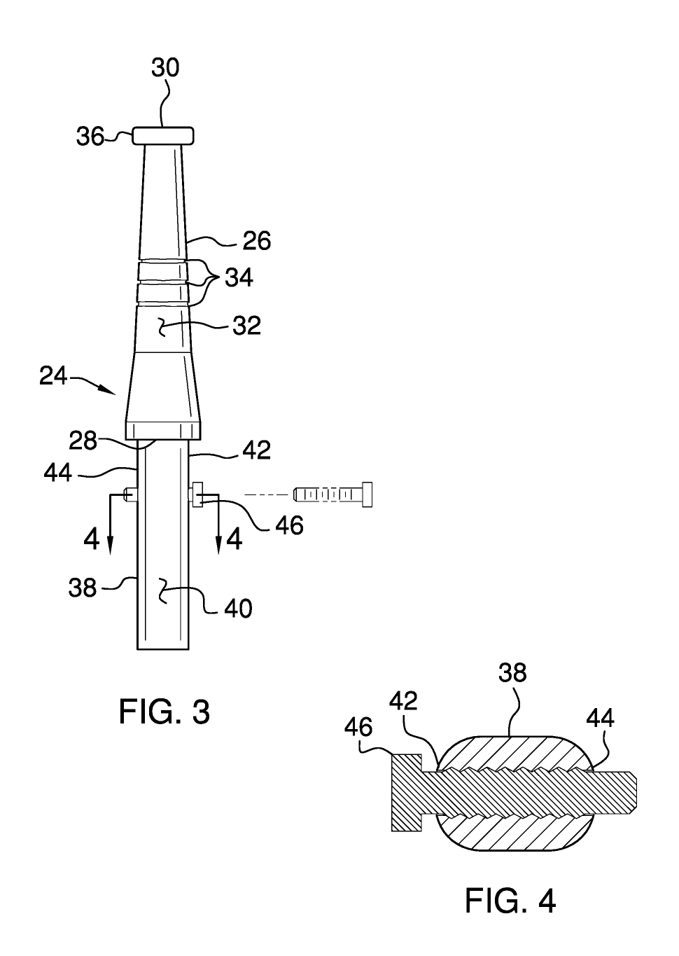

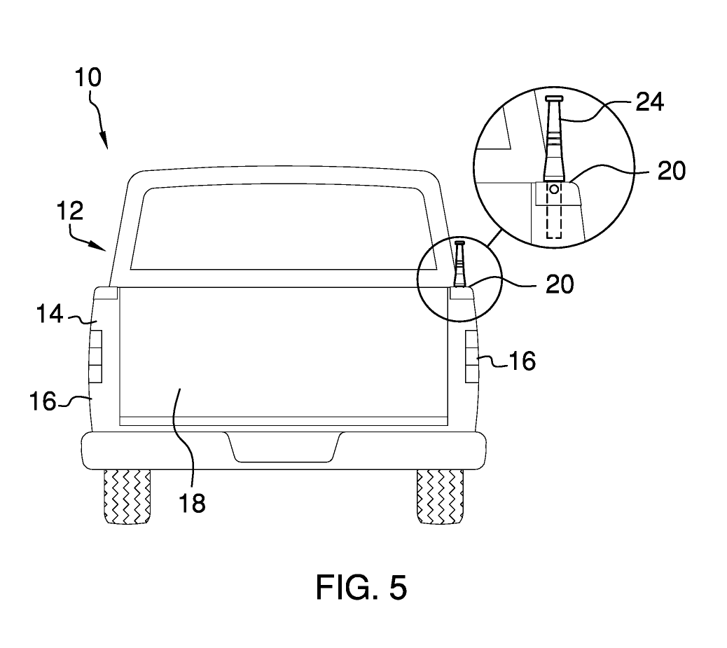

With reference now to the drawings, and in particular to FIGS. 1 through 5 thereof, a new handle device embodying the principles and concepts of an embodiment of the disclosure and generally designated by the reference numeral 10 will be described.

As best illustrated in FIGS. 1 through 5, the handle system 10 generally comprises a vehicle 12 that has a bed 14. The vehicle 12 may be a pickup, a flat bed 14 truck, a box truck or any vehicle 12 commonly used to transport an object. The bed 14 has a pair of lateral walls 16 and a tailgate 18. Each of the lateral walls 16 has a top edge 20 and the top edge 20 corresponding to each of the lateral walls 16 has a well 22 extending downwardly therein. The well 22 may be aligned with the tailgate 18 and the tailgate 18 facilitates entering and exiting the bed 14.

A handle unit 24 is coupled to the bed 14 and the handle unit 24 may be gripped thereby assisting a user to climb into the bed 14. The handle unit 24 comprises a grip 26 that has a first end 28, a second end 30 and an outer surface 32 extending therebetween. The outer surface 32 is continuous such that the grip 26 has a cylindrical shape to enhance gripping the grip 26.

The outer surface 32 has a plurality of grooves 34 that each extends around a perimeter of the grip 26 to enhance gripping the grip 26. The grooves 34 are spaced apart from each other and grooves 34 are centrally positioned between the first end 28 and the second end 30. The outer surface 32 tapers inwardly between the first end 28 and the second end 30 to define a lip 36 extending outwardly from the second end 30. The lip 36 inhibits a hand from sliding off of the grip 26 when a user is climbing into the bed 14.

A shaft 38 is coupled to and extends away from the first end 28 of the grip 26. The shaft 38 has an outermost surface 40 and the outermost surface 40 has a first side 42 and a second side 44. The first side 42 is spaced from the second side 44 such that the shaft 38 has an ovoid cross section taken along a line extending through the first 28 and second 30 ends of the grip 26. The shaft 38 is selectively inserted into the well 22 in a selected one of the lateral walls 16 of the bed 14 having the first end 28 of the grip 26 abutting the top edge 20 of the selected lateral wall.

A fastener 46 is provided and the fastener 46 is selectively extended through the shaft 38 and engages the bed 14. In this way the handle unit 24 is removably retained on the bed 14. The fastener 46 extends through the first 42 and second 44 sides of the shaft 38 and the fastener 46 may comprise a screw or the like. Moreover, the fastener 46 may be threaded to threadably engage the shaft 38.

In use, the shaft 38 is inserted into the well 22 in a selected one of the lateral walls 16 of the bed 14. The fastener 46 is extended through the shaft 38 to engage the bed 14. The grip 26 is gripped when the user is climbing into the bed 14. In this way the grip 26 assists with climbing into and out of the bed 14 and the grip 26 reduces the chances for injury resulting from falling while climbing into and out of the bed 14. The shaft 38 is removed from the well 22 at any selected time.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A handle system being configured to assist a user to climb into a bed of a pickup, said system comprising:
a vehicle having a bed, said bed having a pair of lateral walls and a tailgate, each of said lateral walls having a top edge, said top edge corresponding to each of said lateral walls having a well extending downwardly therein, said well being aligned with said tailgate; and
a handle unit being coupled to said bed wherein said handle unit is configured to be gripped thereby assisting a user to climb into said bed, said handle unit comprising a grip having a first end, a second end and an outer surface extending therebetween, said outer surface being continuous such that said grip has a cylindrical shape wherein said outer surface is configured to enhance gripping said grip, said outer surface tapering inwardly between said first end and said second end wherein a portion of said outer surface facing a front of said vehicle is angled relative to said bed to extend upwardly and rearwardly when said handle unit is coupled to said bed, said outer surface tapering to define a lip extending outwardly from said second end wherein said lip is configured to inhibit a hand from sliding off of said grip.

2. (canceled)

3. (canceled)

4. The system according to claim 1, further comprising:
a shaft being coupled to and extending away from said first end of said grip, said shaft having an outermost surface, said outermost surface having a first side and a second side, said shaft being selectively inserted into said well in a selected one of said lateral walls of said bed having said first end of said grip abutting said top edge of said selected lateral wall.

5. The system according to claim 4, further comprising a fastener being selectively extended through said shaft and engaging said bed such that said handle is retained on said bed, said fastener extending through said first and second sides of said shaft.

6. A handle system being configured to assist a user to climb into a bed of a pickup, said system comprising:
a vehicle having a bed, said bed having a pair of lateral walls and a tailgate, each of said lateral walls having a top edge, said top edge corresponding to each of said lateral walls having a well extending downwardly therein; and
a handle unit being coupled to said bed wherein said handle unit is configured to be gripped thereby assisting a user to climb into said bed, said handle unit comprising:
a grip having a first end, a second end and an outer surface extending therebetween, said outer surface being continuous such that said grip has a cylindrical shape wherein said outer surface is configured to enhance gripping said grip, said outer surface tapering inwardly between said first end and said second end wherein a portion of said outer surface facing a front of said vehicle is angled relative to said bed to extend upwardly and rearwardly when said handle unit is coupled to said bed, said outer surface tapering to define a lip extending outwardly from said second end wherein said lip is configured to inhibit a hand from sliding off of said grip,
a shaft being coupled to and extending away from said first end of said grip, said shaft having an outermost surface, said outermost surface having a first side and a second side, said shaft being selectively inserted into said well in a selected one of said lateral walls of said bed having said first end of said grip abutting said top edge of said selected lateral wall, and
a fastener being selectively extended through said shaft and engaging said bed such that said handle is retained on said bed, said fastener extending through said first and second sides of said shaft.
